(19) United States
(12) Patent Application Publication
(10) Pub. No.: US 2011/0030708 A1
(43) Pub. Date: Feb. 10, 2011

(54) Absorptive Polymer, Compound Fiber and Cigarette Filter Rod Made of Compound Fiber

(75) Inventors: JIANMIN CUI, Bejing (CN); SHUJUN TAN, Bejing (CN)

Correspondence Address: GLOBAL IP SERVICES, 7285 W. Eagle Court, Winton, CA, 95388, US

(73) Assignee: Bright Chemical Science & Technology Development Center, Beijing, Beijing (CN)

(21) Appl. No.: 12/901,359

(22) Filed: Oct. 8, 2010

Related U.S. Application Data
(63) Continuation-in-part of application No. 11/278,703, filed on Apr. 5, 2006, now abandoned.

(30) Foreign Application Priority Data
Apr. 7, 2005 (CN) 200520011670.X

(51) Int. Cl. A24D 3/08; B01J 20/26

(52) U.S. Cl. 131/332; 502/402

(57) ABSTRACT

An absorptive polymer, which is an aqueous emulsion made from copolymerization of neutral unsaturated monomers, unsaturated lipophilic monomers and unsaturated hydrophilic monomers, in the proportion of 50:26-37:14-25 in weight. A compound fiber comprising cigarette filter rod fiber as core and surface layer absorptive polymer; the cigarette filter rod fiber is polypropylene fiber or cellulose acetate fiber; lipophilic groups of the absorptive polymer are attached to polypropylene fiber of cigarette filter rod.

### CROSS REFERENCE TO RELATED PATENT APPLICATION

The present application is a continuation in part application of U.S. application Ser. No. 11/278,703 filed on Apr. 5, 2006, which claims the priority benefit of the Chinese patent application No. 200520011670.X filed on Apr. 7, 2005, the of U.S. application Ser. No. 11/278,703 and Chinese patent application No. 200520011670.X are incorporated herein by references.

### FIELD OF THE INVENTION

The invention relates to an absorptive polymer with hydrophilic and lipophilic groups, compound fiber containing the absorptive polymer and cigarette filters made of the compound fiber.

### BACKGROUND OF THE INVENTION

In recent years, due to the influence of World Health Organization and various anti-smoking movements, some developed countries have started limiting the component of tar, nicotine, and carbon monoxide, etc in the cigarettes. The raised health awareness of consumers also pushes manufacturers to produce cigarette products with lower levels of harmful substances, to reduce the damage to consumers.

As shown in FIG. 1, cigarette filter rods are usually cylindrical rods of size 7.7.times.120 mm (D. times. L) or the scale thereabout. The filter rods are cut into segments of certain lengths and attached to the cigarette as a filter mechanism while smoking cigarettes. On the outside of the rod is paper. The paper tube is filled with tow of fibers in parallel with the cylindrical axis. The fibers are usually Cellulose acetate fiber, Polypropylene fiber, etc. Polypropylene fiber has an alkyl surface, and is chemically inactive. Cellulose acetate fiber has a mostly acetate surface, and is average in the level of chemical activity. These chemical characteristics limit the effectiveness of filter rods for reducing tar and removing harmful substances.

### SUMMARY OF THE INVENTION

The present invention provides an absorptive polymer which can absorb harmful substances in the cigarette smoke. Further, this invention provides compound fiber made of cigarette fiber and the above mentioned absorptive polymer, cigarette filter rod made of the compound fibers.

The present invention provides an absorptive polymer; the polymer is aqueous emulsion made from copolymerization of neutral unsaturated monomers, unsaturated lipophilic monomers and unsaturated hydrophilic monomers, in the proportion of 50:26-37:14-25 in weight; the polymer is of the following structural formula:

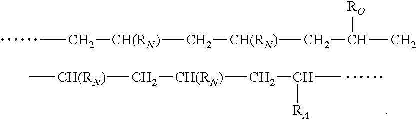

In the formula:

The main chain is made from polymerization of ethene groups, with neutral acetate groups of unsaturated neutral monomers as the main part; the unsaturated neutral monomers are vinyl acetate and/or ethyl methacrylate; R_{N} is neutral acetate group from vinyl acetate and/or ethyl methacrylate;
R₀ is lipophilic group from at least one of the lipophilic monomers: styrene, 2-ethylhexyl methacrylate, dodecyl methacrylate, and isobornyl methacrylate;
R_{A} is hydrophilic group from at least one of the unsaturated hydrophilic monomer of methacrylic acid, methacrylate, acrylic acid, acrylate, and maleic acid, maleate.

Preferably, the unsaturated lipophilic monomer is at least one of 2-ethylhexyl methacrylate and styrene; the neutral unsaturated monomer is vinyl acetate; the hydrophilic monomers: methacrylic acid, methacrylate (K⁺, Na⁺, NH₄⁺), acrylic acid, acrylate (K⁺, Na⁺, NH₄⁺), acrylamide, maleic acid and maleate (K⁺, Na⁺, NH₄⁺).

Preferably, the polymer material is made by copolymerization of the following materials according to the following proportion in weight:

Unsaturated lipophilic monomers: 18-25 2-ethylhexyl methacrylate, 8-12 styrene; unsaturated neutral monomers: 50 vinyl acetate; unsaturated hydrophilic monomers: 6-13 at least one of methacrylic acid, methacrylate, acrylic acid, acrylate, 8-12 at least one of maleic acid and maleate.

The present invention also provides a compound fiber; the compound fiber comprises cigarette filter rod fiber as core and surface layer absorptive polymer; the absorptive polymer are the above-mentioned aqueous emulsion copolymers; the cigarette filter rod fiber is polypropylene fiber or cellulose acetate fiber; lipophilic groups of the absorptive material are attached to polypropylene fiber of cigarette filter rod.

The present invention also provides a cigarette filter rod made of the compound fiber, which has a cylinder comprising paper tube as outer shell, the above mentioned compound fibers which is filled in said paper tube in parallel with the axis of said cylinder and curled; said compound fibers being interconnected.

The present invention provides a compound fiber made of cigarette fiber tow and the above mentioned absorptive polymer, further, a cigarette filter rod made of the compound fibers. The filter rod possesses the following characteristics:

1. The filter rod's physical attributes, such as circumference, roundness hardness, and draw resistance comply with filter rod requirements of a cigarette.
2. The filter rod has strong adsorptive filter materials with larger surface area, and it is effective in filtering tar, carbon monoxide, free radicals, and other harmful substances in cigarette smoke.
3. The filter rod does not negatively affect the taste of the cigarette.
4. The filter rod is non-toxic, tasteless, and high safety. The filter rod is safely produced in a clean environment with no unpleasant smells.

### BRIEF DESCRIPTION OF THE DRAWINGS

FIG. 1 is a perspective view of the cigarette filter rod.

FIG. 2 is a cross section view of the cigarette filter rod.

FIG. 3 is an enlarged view of part A in FIG. 2.

FIG. 4 is a schematic representation showing the structure of the compound fiber.

FIG. 5 is a schematic representation showing the absorptive material.

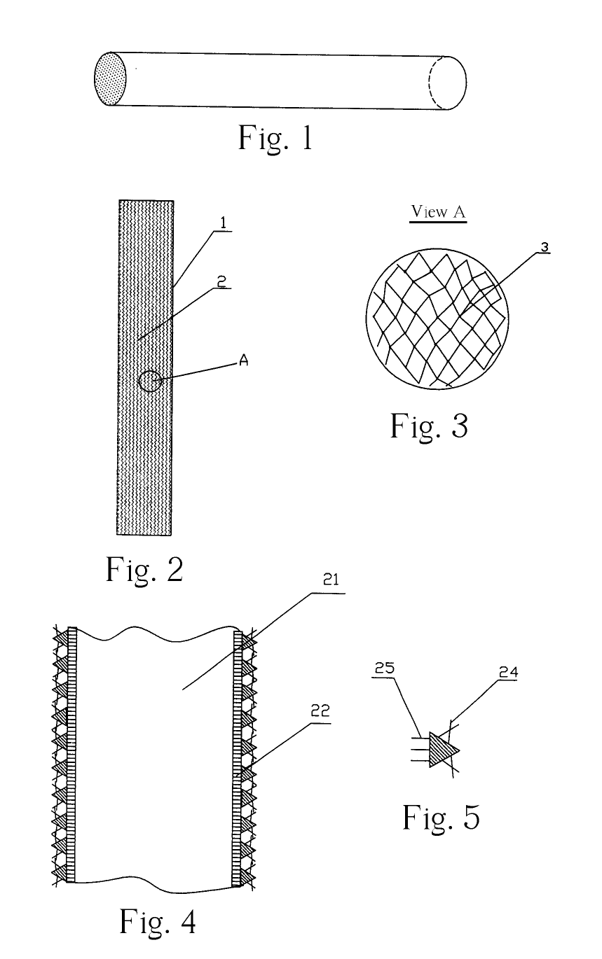

### DETAILED DESCRIPTION OF THE INVENTION

The present invention provides an absorptive polymer; the polymer is aqueous emulsion made from copolymerization of neutral unsaturated monomers, unsaturated lipophilic monomers and unsaturated hydrophilic monomers, in the proportion of 50:26-37:14-25 in weight; the polymer is of the following structural formula:

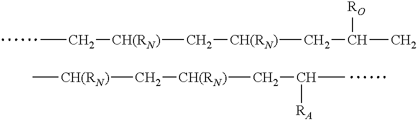

In the formula:

The main chain is made from polymerization of ethene groups, with neutral acetate groups of unsaturated neutral monomers as the main part; the unsaturated neutral monomers are vinyl acetate and/or ethyl methacrylate; R_{N} is neutral acetate group from vinyl acetate and/or ethyl methacrylate;
R₀ is lipophilic group from at least one of the lipophilic monomers: styrene, 2-ethylhexyl methacrylate, dodecyl methacrylate, and isobornyl methacrylate;
R_{A} is hydrophilic group from at least one of the hydrophilic monomers: methacrylic acid, methacrylate (K⁺, Na⁺, NH₄), acrylic acid, acrylate (K⁺, Na⁺, NH₄⁺), acrylamide, maleic acid and maleate (K⁺, Na⁺, NH₄⁺).

Firstly, unsaturated neutral monomers, unsaturated lipophilic monomers and unsaturated hydrophilic monomers are polymerized through conventional method to form aqueous emulsion polymer; such kind of aqueous emulsion copolymer is used to make compound fiber; further, a cigarette filter rod is made of the compound fiber. In the process to make the cigarette filter rod, the compound fiber and cigarette filter rod can be made at the stages of opening and loosening fiber tow, spraying or applying aqueous emulsion and forming filter rod. The aqueous emulsion copolymer is of 45% nonvolatility and 30-80 Mps viscosity, using peristaltic metering pumps and through the method of spraying or applying; the uniformity of spraying aqueous emulsion is not less than 90%; the layer thickness is controlled by controlling the amount applied. After evaporating water of the aqueous emulsion copolymer, the compounding of fiber and the forming of compound fiber filter rod are finished at the same time.

To increase the compound fiber filter rod's effectiveness in reducing tar and other harmful substances, other materials can also be added to the aqueous emulsion, such as porous absorbers, Chinese medicinal herb extracts, biochemical substances, and other strong adsorptive material against harmful substances in tobacco smoke.

The aqueous emulsion copolymer can be added with 2-6% nanometer-porous silica, i.e., with addition of a porous adsorbent. 0.2-2% tea polyphenol, VC, VE, or herbal ingredients is added into aqueous emulsion copolymer, which can help selectively adsorb and filter out radicals and other harmful substances.

The preferable embodiment of the present invention has the following elements: unsaturated lipophilic monomers: 18-25 2-ethylhexyl methacrylate, 8-12 styrene; unsaturated neutral monomers: 50 vinyl acetate; unsaturated hydrophilic monomers: 6-13 at least one of methacrylic acid, methacrylate, acrylic acid, acrylate, 8-12 at least one of maleic acid and maleate. The above monomers are copolymerized and form aqueous emulsion copolymer; the aqueous emulsion copolymer, with acetate as the main part, is embedded and linked with lipophilic group 2-ethylhexyl and benzene ring, as well as hydrophilic group—(meth) acrylic acid (-ate) and maleic acid (-ate) ionic groups. The acetate in the main part is equivalent to acetate ester in cellulose acetate fiber, while the longer aliphatic carbon chain and benzene ring at the lipophilic end not only contribute to the affinity with polyolefin fiber surface and also help absorb harmful benzene ingredients in the smoke. The hydrophilic end increases the absorptive polymer polarity, which significantly extends the absorption capacity of the compound fiber.

In addition to aqueous emulsion copolymer of methacrylic acid, methacrylate, acrylic acid, acrylate, and maleic acid, maleate, the kinds of copolymer can also have a variety of changes: e.g., one end of maleic acid—carboxylic acid can be esterified to benzyl alcohol ester, and the other end—carboxylic acid forms amine salt; such change of the monomer—maleic acid makes itself one end lipophilic and the other end hydrophilic.

Example: unsaturated lipophilic monomers: 22 2-ethylhexyl methacrylate, 10 styrene; unsaturated neutral monomers: about 50 vinyl acetate; hydrophilic monomer: 10 methacrylic acid (-ate), 8 maleic acid (-ate). The above monomers are copolymerized and form aqueous emulsion copolymer. The aqueous emulsion copolymer is used to make polypropylene compound fiber (APP) filter rod. That is to say, this example obtains a compound fiber filter rod made of aqueous emulsion copolymer by compounding methacrylic acid, methacrylate, acrylic acid, acrylate, and maleic acid, maleate.

As shown in the FIG. 2, the filter rod of cigarette made of compound fiber in the present invention has an outer shell paper tube (1). The paper tube (1) is filled with tow of compound fibers (2) in parallel with the cylindrical axis and be curled. The fibers are interconnected (3) to form a filter rod with high permeability.

The compound fibers within the paper tube have the total count of 9000 or greater, optimally, 12000 or greater.

As shown in FIG. 4, said compound fiber (2) comprises a core (21) and a surface layer (22). The core (21) (or carrier, supporter, framework) is generally cigarette filter fibers, such as polypropylene fiber, cellulose acetate fiber, etc. The surface layer (22) comprises adsorptive material(s).

The core (21) generally has a diameter of 20.mu.m or thinner (.ltoreq.20.mu.m) and the surface layer 0.6.mu.m or greater (.gtoreq.0.6.mu.m).

As shown in FIG. 5, the adsorptive material has an affinity to the fiber core. As shown, one side is hydrophilic (24), and the other side lipophilic (25). The lipophilic material attaches the adsorptive material to the core, while also completes the inter-fiber “welding”. In other words, this adsorptive material builds the construction of the compound filter rod.

Shanghai Tobacco (Group) Corporation Technical Center has tested the cigarettes made of polypropylene compound fiber (APP) filter rod and has a sensory assessing of smoking, VOC testing and smoke testing of the cigarette. The results are as follows:

### 1. SMOKE INDICATORS

| | DaQianMen | | | |
|---|---|---|---|---|
| | cigarette with | | | |
| | filter rod made | DaQianMen | | |
| | of cellulose | cigarette with | | |
| Species | acetate fiber | APP filter rod | Unit | Standard |
| Tar yield | 14.10 | 14.30 | mg | 15.10 |
| Nicotine yield | 1.03 | 1.02 | mg | 1.10 |
| CO | 13.08 | 13.40 | mg | — |
| Average PDC | 1297 | 1267 | Pa | — |
| Resistance to | 5.2 | 5.6 | % | — |
| Draw SD | | | | |
| Average weight | 0.917 | 0.960 | G | — |
| Weight SD | 0.023 | 0.025 | % | — |
| Average puffs | 8.7 | 8.8 | Puff | — |
| Hardness | 72.88 | 75.17 | % | — |
| Specifications | (20 + 64) × 24.5 | (20 + 64) × 24.5 | — | — |

The testing data shows that the general indicators of DaQianMen cigarette with APP filter rod are close to DaQianMen cigarette with cellulose acetate fiber filter rod; the SD indicator of resistance to draw of DaQianMen cigarette with APP filter rod is slightly higher than DaQianMen cigarette with cellulose acetate fiber filter rod.

### 2. COMPARATIVE ANALYSIS

(1) Comparison of Cigarette Atmosphere when Opening Package

The atmosphere of DaQianMen cigarette with APP filter rod is generally close to that of DaQianMen cigarette with cellulose acetate fiber filter rod, both with lower contents of ethanol, acetic acid, acetone, styrene, etc volatile organic compounds.

### (2) VOC Analysis of Compound Filter Rod Absorptive Polymer of APP

In the compound filter rod absorptive polymer of APP, no significant amount of compound of special attention and control is found.

### 3. SENSORY ASSESSING OF CIGARETTE SMOKING

Cigarette samples for assessing of smoking: DaQianMen cigarette with compound filter rod made of APP (A), compared with DaQianMen cigarette with filter rod made of cellulose acetate fiber (B).

| Sam- | | | | | | After- | |
|---|---|---|---|---|---|---|---|
| ple | Luster | Aroma | Harmony | Odor | Pungency | taste | Total |
| A | 4.5 | 28.1 | 4.3 | 11.9 | 12.8 | 13.8 | 75.4 |
| B | 4.5 | 27.8 | 4.2 | 11.8 | 12.7 | 13.6 | 74.6 |

The preliminary experimentation shows that DaQianMen cigarette with compound filter rod made of APP is relatively close with DaQianMen cigarette with filter rod made of cellulose acetate fiber in respect of aroma, odor and pungency indicators.

### 4. CONCLUSION

In summary of the above experimentation results, the cigarette with compound filter rod made of APP is close to the cigarette with filter rod made of cellulose acetate fiber in respect of general indicators and performance.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. An absorptive polymer, which is aqueous emulsion made from copolymerization of neutral unsaturated monomers, unsaturated lipophilic monomers and unsaturated hydrophilic monomers, in the proportion of 50:26-37:14-25 in weight; the polymer is of the following structural formula: 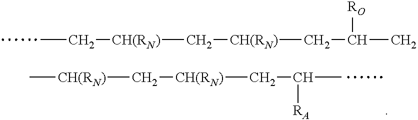
In the formula:
The main chain is long chain of polymerization of ethene groups, with neutral acetate groups of neutral unsaturated monomers as the main part; the unsaturated neutral monomers are vinyl acetate and/or ethyl methacrylate; R_{N} is neutral acetate group from vinyl acetate and/or ethyl methacrylate;
R₀ is lipophilic group from at least one of the lipophilic monomers: styrene, 2-ethylhexyl methacrylate, dodecyl methacrylate, and isobornyl methacrylate;
R_{A} is hydrophilic group from at least one of the unsaturated hydrophilic monomer of methacrylic acid, methacrylate, acrylic acid, acrylate, and maleic acid, maleate.

2. The absorptive polymer of claim 1, wherein the unsaturated lipophilic monomer is at least one of 2-ethylhexyl methacrylate and styrene; the neutral unsaturated monomer is vinyl acetate; the hydrophilic monomers: methacrylic acid, methacrylate (K⁺, Na⁺, NH₄⁺), acrylic acid, acrylate (K⁺, Na⁺, NH₄⁺), acrylamide, maleic acid and maleate (K⁺, Na⁺, NH₄⁺).

3. The absorptive polymer of claim 1, wherein the polymer material is made by copolymerization of the following materials according to the following proportion in weight:
Unsaturated lipophilic monomers: 18-25 2-ethylhexyl methacrylate; 8-12 styrene; unsaturated neutral monomers: 50 vinyl acetate; unsaturated hydrophilic monomers: 6-13 at least one of methacrylic acid, methacrylate, acrylic acid, acrylate, 8-12 at least one of maleic acid and maleate.

4. A compound fiber comprising cigarette filter rod fiber as core and surface layer absorptive polymer; the absorptive polymers could be any one of the above-mentioned aqueous emulsion copolymers and absorptive polymers in claims 1-3; the cigarette filter rod fiber is polypropylene fiber or cellulose acetate fiber; lipophilic groups of the absorptive material are attached to polypropylene fiber of cigarette filter rod.

5. A cigarette filter made of compound fiber, which is cylinder comprising paper tube as outer shell, the said compound fibers in claim 4 which is filled in said paper tube in parallel with the axis of said cylinder and curled; said compound fibers being interconnected.
